(19) United States
(12) Patent Application Publication
(10) Pub. No.: US 2017/0252968 A1
(43) Pub. Date: Sep. 7, 2017

(54) APPARATUS AND METHOD FOR PRINTING MULTI-COLOR THREE DIMENSIONAL OBJECT

(71) Applicants: INVENTEC APPLIANCES (PUDONG) CORPORATION, Shanghai (CN); INVENTEC APPLIANCES CORP., New Taipei City (TW); Inventec Appliances (Shanghai) Co. Ltd., Shanghai (CN)

(72) Inventors: Jin Wang, Shanghai (CN); Wei Shen, Shanghai (CN); Shih-Kuang Tsai, Shanghai (CN)

(21) Appl. No.: 15/270,131

(22) Filed: Sep. 20, 2016

(30) Foreign Application Priority Data
Mar. 7, 2016 (CN) 201610126105.0

(51) Int. Cl. B29C 67/00; B33Y 30/00; B33Y 10/00

(52) U.S. Cl. CPC B29C 67/0055; B33Y 10/00; B33Y 30/00

(57) ABSTRACT

A method for printing a multi-color three dimensional (3D) object includes the following steps. A 3D object is layered to configure multiple layer-printing documents. The multiple layer-printing documents are integrated into a model printing document of the 3D object. The 3D object is printed according to the model printing document.

This application claims the benefit of People's Republic of China application Serial No. 201610126105.0, filed Mar. 7, 2016, the subject matter of which is incorporated herein by reference.

### TECHNICAL FIELD

The disclosure relates to a printing technology, especially an apparatus for printing a multi-color three dimensional object and a method thereof.

### BACKGROUND

Three-dimensional (3D) printing is a form of additive manufacturing technology. In the additive manufacturing technology, a 3D object is created by continues physical layers outputted by a 3D printer. To compare with other additive manufacturing technologies, a 3D printer has many advantages, such as faster printing speed, lower cost, and higher serviceability. A 3D printer is an apparatus for outputting a real 3D object. 3D printing is identical to the laser molding technology in functionality. A 3D printer processes and forms a 3D object which is printed iteratively, i.e. the 3D printer creates the 3D object layer by layer. It is completely different from conventional material elimination technology. The process of forming a 3D object layer by layer is similar to the process of printing by an ink jet printer. That is why a 3D printer is called as a 3D printer.

At the present time, when a 3D printer prints a 3D object, model profile information is obtained firstly. Secondly, a universal printing parameter message which is configured in advance is adopted to print the 3D object according to the model profile information of the 3D object. Finally, the 3D object is obtained.

The 3D printing can print a 3D object by using a single-nozzle 3D printer or a multi-nozzle 3D printer. The single-nozzle 3D printer prints a 3D object by using only one color, i.e. the printed 3D object is monochromatic. The number of colors which a 3D printer can print out corresponds to the number of nozzles of the 3D printer. The edge between adjacent color areas of a 3D object which is printed in multi-color is clear. A 3D printer with two nozzles has two inlets for inputting color materials and can print a 3D object in mixed color. The color mixing principle is to mix printing materials having different colors and distinct physical properties. However, the disadvantage is that the change of color which the 3D printer outputs is gradual but not fast because the color material is left over at the nozzle of the 3D printer.

Based on the above, regardless of which of the above-mentioned 3D printing methods, there are some problems in the 3D printing methods, such as that the color cannot be mixed or the effect of color mixture is not good.

### SUMMARY

The disclosure relates to an apparatus for printing a multi-color three dimensional object and a method thereof. The effect of color mixture for printing a multi-color three dimensional object is increased by stacking layers having different colors and different heights.

According to the first aspect of the present invention, a method for printing a multi-color three dimensional (3D) object is provided. The method for printing a multi-color three dimensional (3D) object comprises the following steps: A 3D object is layered to configure a plurality of layer-printing documents. The plurality of layer-printing documents is integrated into a model printing document of the 3D object. The 3D object is printed according to the model printing document.

According to the second aspect of the present invention, an apparatus for printing a multi-color three dimensional (3D) object is provided. The apparatus for printing the multi-color 3D object comprises a document setting unit and a document processing unit. The document setting unit is used for layering a 3D object to configure a plurality of layer-printing documents. The document processing unit is used for integrating the plurality of layer-printing documents into a model printing document of the 3D object; wherein a multi-nozzle 3D printer prints the 3D object according to the model printing document.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart for printing a multi-color three dimensional (3D) object.

FIG. 2 shows a flowchart for printing a multi-color three dimensional (3D) object according to an embodiment of this disclosure.

FIG. 3 shows a flowchart for printing another multi-color 3D object according to another embodiment of this disclosure.

FIG. 4 shows a flowchart for printing another multi-color 3D object according to another embodiment of this disclosure.

FIG. 5 shows a diagram illustrating an apparatus for printing a multi-color 3D object according to an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In order to increase the effect of color mixture for printing a multi-color three dimensional object, the multi-color three dimensional (3D) object with various colors is layered to configure a plurality of layer-printing documents when configuring a model printing document of the 3D object. Each of the layer-printing documents includes a color information and a layer-height information corresponding to the color information. The plurality of layer-printing documents is integrated into the model printing document of the 3D object. The model printing document is input into a multi-nozzle 3D printer to print the 3D object.

As such, the advantages of a multi-nozzle 3D printer are kept, and the disadvantage which a single-nozzle 3D printer cannot mix colors is avoided. Moreover, the color mixing principle of present disclosure is entirely different from the color mixing principle of a two-nozzle 3D printer of known technology. The effect of color mixture for printing a multi-color three dimensional object is increased by stacking layers having different colors and different heights.

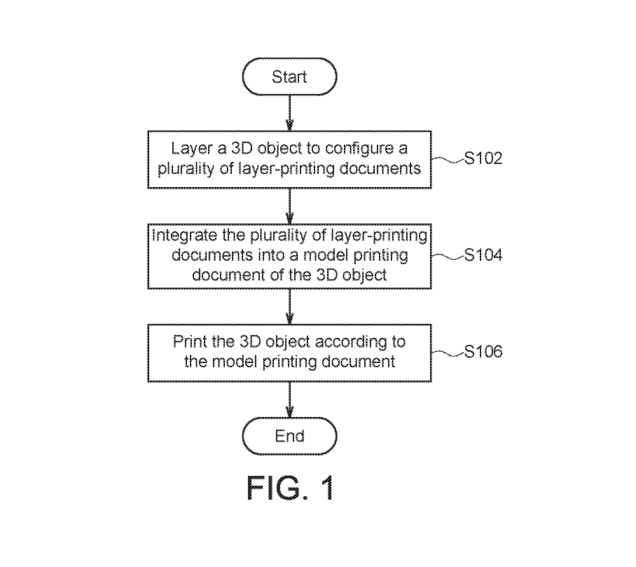

FIG. 1 shows a flowchart for printing a multi-color three dimensional (3D) object. At step S102, a 3D object is layered to configure a plurality of layer-printing documents. When configuring the plurality of layer-printing documents of the 3D object, the 3D object is layered according to colors of the 3D object to configure the plurality of layer-printing documents. A number of the plurality of layer-printing documents is determined by a number of colors relating to the 3D object. Each of the plurality of layer-printing documents includes a color information and a layer-height information corresponding to the color information. The layer-height information includes a layer-height value. The plurality of layer-printing documents is composed of a plurality of triangle meshes.

After step S102, the plurality of layer-printing documents is integrated into a model printing document of the 3D object at step S104. At step S104, the plurality of layer-printing documents can be integrated into the model printing document of the 3D object according to a height of the 3D object and a printing order of a bottom up.

Then, at step S106, the 3D object is printed according to the model printing document. The model printing document can be input into a multi-nozzle 3D printer to print the 3D object at step S106. If the multi-nozzle 3D printer has much more nozzles, the multi-nozzle 3D printer can print much more colors. The multi-nozzle 3D printer can control its subsystem to further layer each layer of the 3D object to sublayers.

To be more precisely, the color information of each layer-printing document of the 3D object can include a grayscale color mixing ratio or a color mixing ratio. The grayscale color mixing ratio determines a ratio relationship between black color and white color, and the color mixing ratio determines a ratio relationship between three primary colors, i.e. red color, yellow color and blue color. The layer-height information of each layer-printing document of the 3D object further includes a plurality of sub-layer-height values. The plurality of sub-layer-height values correspond to the grayscale color mixing ratio included in the color information or the color mixing ratio included in the color information. The plurality of sub-layer-height values is determined according to the layer-height value and the grayscale color mixing ratio or the color mixing ratio.

Various embodiments presented below and described in detail, embodiments are merely described as an example, it does not narrow down the scope of the invention to be protected. In addition, the embodiment of the drawings part element omitted to clearly show the technical features of the present invention.

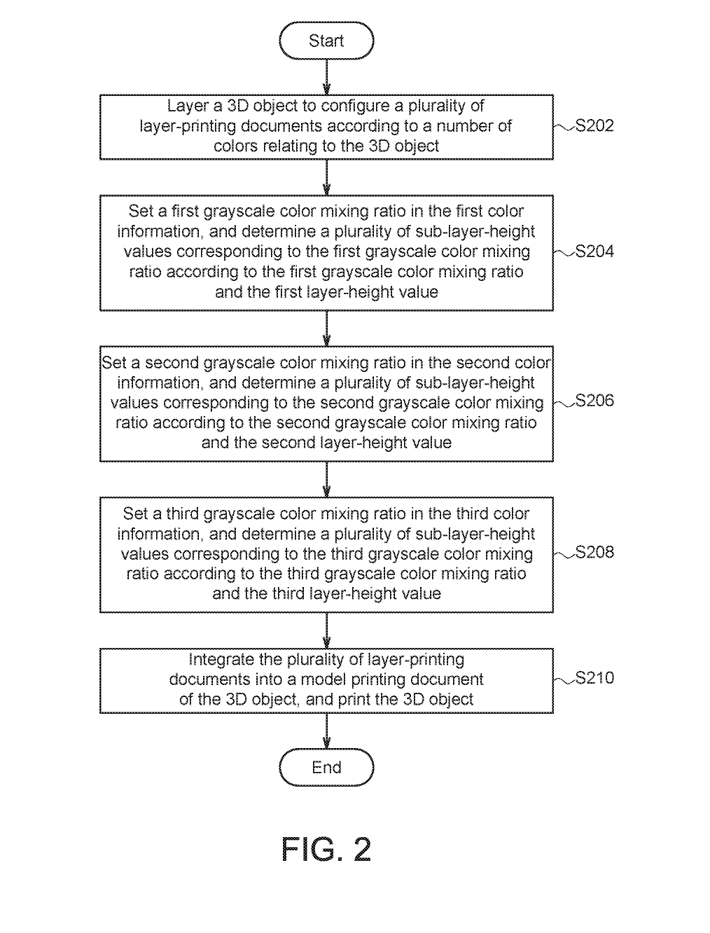

Please refer to FIG. 2 showing a flowchart for printing a multi-color three dimensional (3D) object according to an embodiment of this disclosure. For example, if a 3D object relates to black color, white color and gray color. A two-nozzle 3D printer can be used to utilize black color and white color to print the 3D object in black, white, and gray colors.

At step S202, the 3D object is layered to configure a plurality of layer-printing documents according to a number of colors relating to the 3D object. In other words, a 3D object with black, white, and gray colors is layered to configure three layer-printing documents, and the three layer-printing documents are composed of three triangle meshes. The three layer-printing documents include a first layer-printing document, a second layer-printing document, and a third layer-printing document. The first layer-printing document includes a first color information and a first layer-height information wherein the first color information is black color and the first height information includes a first layer-height value. The second layer-printing document includes a second color information and a second layer-height information wherein the second color information is white color and the second height information includes a second layer-height value. The third layer-printing document includes a third color information and a third layer-height information wherein the third color information is gray color and the third layer-height information includes a third layer-height value.

At step S204, a first grayscale color mixing ratio in the first color information is set, and a plurality of sub-layer-height values corresponding to the first grayscale color mixing ratio is determined according to the first grayscale color mixing ratio and the first layer-height value. Because the first color is black color, the first grayscale color mixing ratio included in the first color information is used to mix black color and white color according to the ratio of 1:0. Thus, the sub-layer-height value corresponding to black color and the sub-layer-height value corresponding to white color are determined according to the ratio of 1:0 and the first layer-height value, i.e. the first layer-height value is used as the sub-layer-height value corresponding to black color.

At step S206, a second grayscale color mixing ratio in the second color information is set, and a plurality of sub-layer-height values corresponding to the second grayscale color mixing ratio is determined according to the second grayscale color mixing ratio and the second layer-height value. Because the second color is white color, the second grayscale color mixing ratio included in the second color information is used to mix black color and white color according to the ratio of 0:1. Thus, the sub-layer-height value corresponding to black color and the sub-layer-height value corresponding to white color are determined according to the ratio of 0:1 and the second layer-height value, i.e. the second layer-height value is used as the sub-layer-height value corresponding to white color.

At step S208, a third grayscale color mixing ratio in the third color information is set, and a plurality of sub-layer-height values corresponding to the third grayscale color mixing ratio is determined according to the third grayscale color mixing ratio and the third layer-height value. Because the third color is gray color, the third grayscale color mixing ratio included in the third color information is used to mix black color and white color according to the ratio of 1:1. Thus, the sub-layer-height value corresponding to black color and the sub-layer-height value corresponding to white color are determined according to the ratio of 1:1 and the third layer-height value, i.e. half of the third layer-height value is used as the sub-layer-height value corresponding to white color and half of the third layer-height value is used as the sub-layer-height value corresponding to black color for the mixing-color printing.

At step S210, the plurality of layer-printing documents whose color information and layer-height information are further configured in steps S204, S206 and S208 are integrated into a model printing document of the 3D object according to the height of the 3D object and a printing order of a bottom up. The 3D object is printed according to the model printing document.

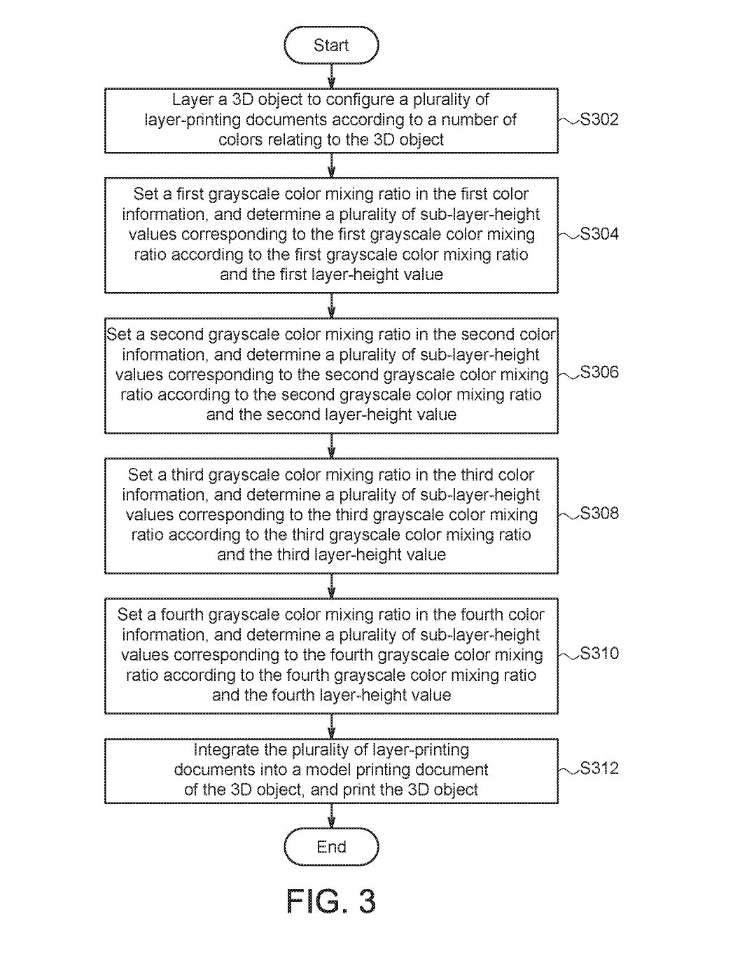

FIG. 3 shows a flowchart for printing another multi-color 3D object according to another embodiment of this disclosure. For example, if a 3D object relates to black color, white color, light gray color, and dark gray color. A two-nozzle 3D printer can be used to utilize black color and white color to print the 3D object in black, white, light gray, and dark gray colors.

At step S302, the 3D object is layered to configure a plurality of layer-printing documents according to a number of colors relating to the 3D object. In other words, the 3D object with black, white, light gray, and dark gray colors are layered to configure four layer-printing documents, and the layer-printing documents are composed of four triangle meshes. The layer-printing documents include a first layer-printing document, a second layer-printing document, a third layer-printing document, and a fourth layer-printing document. The first layer-printing document includes a first color information and a first layer-height information wherein the first color information is black color and the first height information includes a first layer-height value. The second layer-printing document includes a second color information and a second layer-height information wherein the second color information is white color and the second height information includes a second layer-height value. The third layer-printing document includes a third color information and a third layer-height information wherein the third color information is light gray color and the third layer-height information includes a third layer-height value. The fourth layer-printing document includes a fourth color information and a fourth layer-height information wherein the fourth color information is dark gray color and the fourth layer-height information includes a fourth layer-height value.

At step S304, a first grayscale color mixing ratio in the first color information is set, and a plurality of sub-layer-height values corresponding to the first grayscale color mixing ratio is determined according to the first grayscale color mixing ratio and the first layer-height value. Because the first color is black color, the first grayscale color mixing ratio included in the first color information is used to mix black color and white color according to the ratio of 1:0. Thus, the sub-layer-height value corresponding to black color and the sub-layer-height value corresponding to white color in the first layer-height information are determined according to the ratio of 1:0 and the first layer-height value, i.e. the first layer-height value is used as the sub-layer-height value corresponding to black color.

At step S306, a second grayscale color mixing ratio in the second color information is set, and a plurality of sub-layer-height values corresponding to the second grayscale color mixing ratio is determined according to the second grayscale color mixing ratio and the second layer-height value. Because the second color is dark gray color, the second grayscale color mixing ratio included in the second color information is used to mix black color and white color according to the ratio of 3:1. Thus, the sub-layer-height value corresponding to black color and the sub-layer-height value corresponding to white color in the second layer-height information are determined according to the ratio of 3:1 and the second layer-height value, i.e. three quarters of the second layer-height value is used as the sub-layer-height value corresponding to black color and one quarter of the second layer-height value is used as the sub-layer-height value corresponding to white color.

At step S308, a third grayscale color mixing ratio in the third color information is set, and a plurality of sub-layer-height values corresponding to the third grayscale color mixing ratio is determined according to the third grayscale color mixing ratio and the third layer-height value. Because the third color is light gray color, the third grayscale color mixing ratio included in the third color information is used to mix black color and white color according to the ratio of 1:3. Thus, the sub-layer-height value corresponding to black color and the sub-layer-height value corresponding to white color in the third layer-height information are determined according to the ratio of 1:3 and the third layer-height value, i.e. one quarter of the third layer-height value is used as the sub-layer-height value corresponding to black color and three quarters of the third layer-height value is used as the sub-layer-height value corresponding to white color.

At step S310, a fourth grayscale color mixing ratio in the fourth color information is set, and a plurality of sub-layer-height values corresponding to the fourth grayscale color mixing ratio is determined according to the fourth grayscale color mixing ratio and the fourth layer-height value. Because the fourth color is white color, the fourth grayscale color mixing ratio included in the fourth color information is used to mix black color and white color according to the ratio of 0:1. Thus, the sub-layer-height value corresponding to black color and the sub-layer-height value corresponding to white color in the fourth layer-height information are determined according to the ratio of 0:1 and the fourth layer-height value, i.e. the fourth layer-height value is used as the sub-layer-height value corresponding to white color.

At step S312, the four layer-printing documents whose color information and layer-height information are further configured in steps S304, S306, S308, and S310 are integrated into a model printing document of the 3D object according to the height of the 3D object and a printing order of a bottom up. The 3D object is printed according to the model printing document.

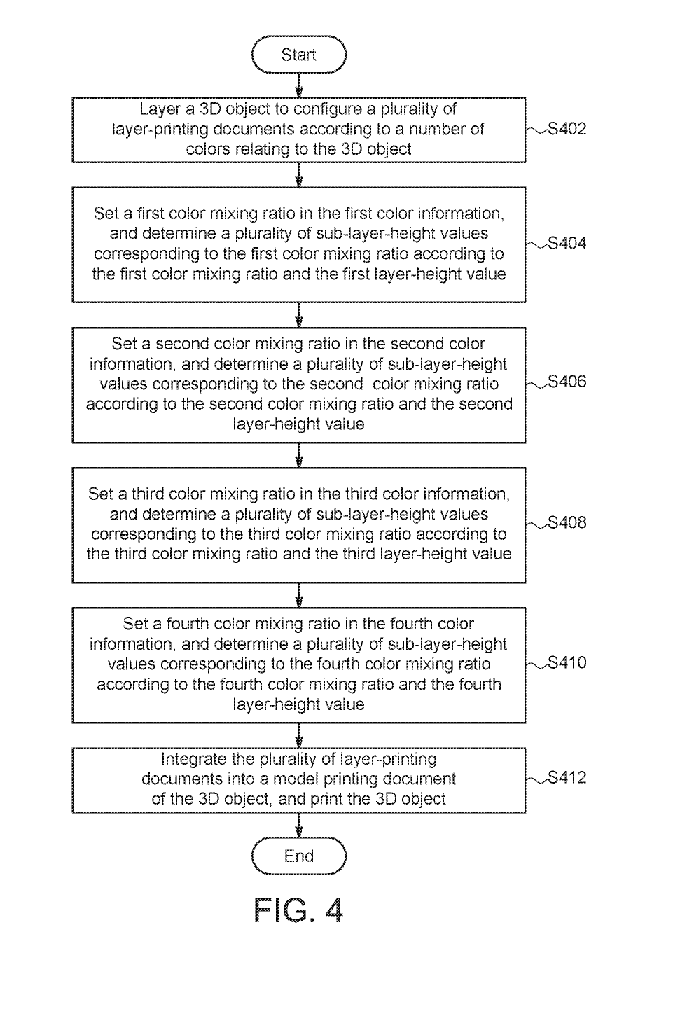

Please refer to FIG. 4 showing a flowchart for printing another multi-color 3D object according to another embodiment of this disclosure. For example, if a three-nozzle 3D printer is used, the three-nozzle 3D printer can utilize three primary colors, i.e. red color, yellow color and blue color, to print a 3D object. The three-nozzle 3D printer can not only print three primary colors, but also print other colors which are not three primary colors according to a color mixing ratio which determines a ratio relationship between three primary colors. For instance, green color can be obtained by mixing yellow color and blue color. Purple color can be obtained by mixing red color and blue color, and orange color can be obtained by mixing red color and yellow color. Moreover, black color can be obtained by mixing red, yellow and blue colors according to the ratio of 1:1:1. Orange-red color can be obtained by mixing red color and yellow color according to the ratio of 2:1, and orange-yellow color can be obtained by mixing red color and yellow color according to the ratio of 1:2. Light green color can be obtained by mixing yellow color and blue color according to the ratio of 2:1.

In the embodiment illustrated in FIG. 4, a 3D object relates four colors which are red color, black color, orange-red color, and blue color.

At step S402, the 3D object is layered to configure a plurality of layer-printing documents according to a number of colors relating to the 3D object. In other words, the 3D object with four various colors is layered to configure four layer-printing documents, and the four layer-printing documents are composed of four triangle meshes. The layer-printing documents include a first layer-printing document, a second layer-printing document, a third layer-printing document, and a fourth layer-printing document. The first layer-printing document includes a first color information and a first layer-height information wherein the first color information is red color and the first height information includes a first layer-height value. The second layer-printing document includes a second color information and a second layer-height information wherein the second color information is black color and the second layer-height information includes a second layer-height value. The third layer-printing document includes a third color information and a third layer-height information wherein the third color information is orange-red color and the third layer-height information includes a third layer-height value. The fourth layer-printing document includes a fourth color information and a fourth layer-height information wherein the fourth color information is blue color and the fourth layer-height information includes a fourth layer-height value.

At step S404, a first color mixing ratio in the first color information is set, and a plurality of sub-layer-height values corresponding to the first color mixing ratio is determined according to the first color mixing ratio and the first layer-height value. Because the first color is red color, the first color mixing ratio included in the first color information is used to mix red color, yellow color and blue color according to the ratio of 1:0:0. Thus, the sub-layer-height value corresponding to red color, the sub-layer-height value corresponding to yellow color and the sub-layer-height value corresponding to blue color are determined according to the ratio of 1:0:0 and the first layer-height value, i.e. the first layer-height value is used as the sub-layer-height value corresponding to red color.

At step S406, a second color mixing ratio in the second color information is set, and a plurality of sub-layer-height values corresponding to the second color mixing ratio is determined according to the second color mixing ratio and the second layer-height value. Because the second color is black color, the second color mixing ratio included in the second color information is used to mix red color, yellow color and blue color according to the ratio of 1:1:1. Thus, the sub-layer-height value corresponding to red color, the sub-layer-height value corresponding to yellow color and the sub-layer-height value corresponding to blue color in the second layer-height information are determined according to the ratio of 1:1:1 and the second layer-height value, i.e. one third of the second layer-height value is used as the sub-layer-height value corresponding to red color, one third of the second layer-height value is used as the sub-layer-height value corresponding to yellow color and one third of the second layer-height value is used as the sub-layer-height value corresponding to blue color.

At step S408, a third color mixing ratio in the third color information is set, and a plurality of sub-layer-height values corresponding to the third color mixing ratio is determined according to the third color mixing ratio and the third layer-height value. Because the third color is orange-red color, the third color mixing ratio included in the third color information is used to mix red color, yellow color and blue color according to the ratio of 2:1:0. Thus, the sub-layer-height value corresponding to red color, the sub-layer-height value corresponding to yellow color and the sub-layer-height value corresponding to blue color in the third layer-height information are determined according to the ratio of 2:1:0 and the third layer-height value, i.e. two thirds of the third layer-height value is used as the sub-layer-height value corresponding to red color, one third of the third layer-height value is used as the sub-layer-height value corresponding to yellow color.

At step S410, a fourth color mixing ratio in the fourth color information is set, and a plurality of sub-layer-height values corresponding to the fourth color mixing ratio is determined according to the fourth color mixing ratio and the fourth layer-height value. Because the fourth color is blue color, the fourth color mixing ratio included in the fourth color information is used to mix red color, yellow color and blue color according to the ratio of 0:0:1. Thus, the sub-layer-height value corresponding to red color, the sub-layer-height value corresponding to yellow color and the sub-layer-height value corresponding to blue color in the fourth layer-height information are determined according to the ratio of 0:0:1 and the fourth layer-height value, i.e. the fourth layer-height value is used as the sub-layer-height value corresponding to blue color.

At step S412, the layer-printing documents whose color information and layer-height information are further configured in steps S404, S406, S408, and S410 are integrated into a model printing document of the 3D object according to the height of the 3D object and a printing order of a bottom up. The 3D object is printed according to the model printing document.

The above embodiments about color mixture are merely described as an example, not intended to limit the scope of the present invention is reduced to be protected.

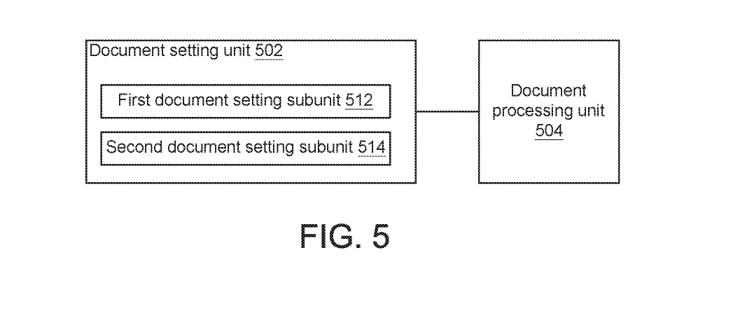

FIG. 5 shows a diagram illustrating an apparatus for printing a multi-color three dimensional (3D) object according to an embodiment of this disclosure. The apparatus is a 3D printer which includes a document setting unit 502 and a document processing unit 504.

The document setting unit 502 is used for layering a 3D object to configure a plurality of layer-printing documents. The plurality of layer-printing documents is configured according to colors of the 3D object when configuring a model printing document of the 3D object. A number of the plurality of layer-printing documents is determined based on a number of colors relating to the 3D object. Each of the plurality of layer-printing documents includes a color information and a layer-height information corresponding to the color information. The layer-height information includes a layer-height value. The plurality of layer-printing documents is composed of a plurality of triangle meshes.

The document setting unit 502 further integrates the plurality of layer-printing documents into the model printing document of the 3D object according to a height of the 3D object and a printing order of a bottom up.

The color information in the layer-printing document can includes a grayscale color mixing ratio or a color mixing ratio. The grayscale color mixing ratio determines a ratio relationship between black color and white color, and the color mixing ratio determines a ratio relationship between three primary colors. The layer-height information in the layer-printing document of the 3D object further includes a plurality of sub-layer-height values. The plurality of sub-layer-height values correspond to the grayscale color mixing ratio or the color mixing ratio which is included in the color information. The plurality of sub-layer-height values is determined according to the layer-height value and the grayscale color mixing ratio or determined according to the layer-height value and the color mixing ratio.

The document setting unit 502 further includes a first document setting subunit 512 for obtaining a target color according to the color mixing ratio and the plurality of sub-layer-height values corresponding to the color mixing ratio. The obtained target color can be three primary colors and other colors which are not three primary colors.

The document setting unit 502 further includes a second document setting subunit 514 for obtaining a target color, e.g. black color, white color or various gray colors with different intensity, according to the grayscale color mixing ratio and the plurality of sub-layer-height values corresponding to the grayscale color mixing ratio.

The document processing unit 504 is used for integrating the plurality of layer-printing documents into a model printing document of the 3D object and then a multi-nozzle 3D printer prints the 3D object according to the model printing document. The document processing unit 504 can inputs the model printing document into the multi-nozzle 3D printer to print the 3D object. The multi-nozzle 3D printer has two nozzles or more than two nozzles.

In the embodiments of the present invention, a 3D object is layered to configure a plurality of layer-printing documents and then the plurality of layer-printing documents is integrated into a model printing document of the 3D object. At last, the 3D object is printed according to the model printing document. As the embodiments illustrated above, the effect of color mixture for printing a multi-color 3D object is increased by stacking layers having different colors and different heights.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for printing a multi-color three dimensional (3D) object, comprising:
layering a 3D object to configure a plurality of layer-printing documents;
integrating the plurality of layer-printing documents into a model printing document of the 3D object; and
printing the 3D object according to the model printing document.

2. The method according to claim 1, wherein a number of the plurality of layer-printing documents are determined by a number of colors relating to the 3D object.

3. The method according to claim 1, wherein the plurality of layer-printing documents are composed of a plurality of triangle meshes.

4. The method according to claim 1, wherein each of the plurality of layer-printing documents includes a color information and a layer-height information corresponding to the color information, and the layer-height information includes a layer-height value.

5. The method according to claim 4, wherein the color information includes a color mixing ratio which determines a ratio relationship between three primary colors, and
the layer-height information further includes a plurality of sub-layer-height values which are determined according to the color mixing ratio and the layer-height value.

6. The method according to claim 5, wherein the step of configuring the plurality of layer-printing documents further comprises:
obtaining a target color according to the color mixing ratio and the plurality of sub-layer-height values corresponding to the color mixing ratio.

7. The method according to claim 4, wherein the color information includes a grayscale color mixing ratio which determines a ratio relationship between black and white, and the layer-height value further includes a plurality of sub-layer-height values which are determined according to the grayscale color mixing ratio and the layer-height value.

8. The method according to claim 7, wherein the step of configuring the plurality of layer-printing documents further comprises:
obtaining a target color according to the grayscale color mixing ratio and the plurality of sub-layer-height values corresponding to the grayscale color mixing ratio.

9. The method according to claim 1, wherein the step of integrating the plurality of layer-printing documents into the model printing document of the 3D object comprises:
integrating the plurality of layer-printing documents into the model printing document of the 3D object according to a height of the 3D object and a printing order of a bottom up.

10. The method according to claim 1, wherein the step of printing the 3D object according to the model printing document comprises:
inputting the model printing document into a multi-nozzle 3D printer to print the 3D object.

11. An apparatus for printing a multi-color three dimensional (3D) object, comprising:
a document setting unit for layering a 3D object to configure a plurality of layer-printing documents; and
a document processing unit for integrating the plurality of layer-printing documents into a model printing document of the 3D object; wherein a multi-nozzle 3D printer prints the 3D object according to the model printing document.

12. The apparatus according to claim 11, wherein a number of the plurality of layer-printing documents is determined by a number of colors relating to the 3D object.

13. The apparatus according to claim 11, wherein the plurality of layer-printing documents are composed of a plurality of triangle meshes.

14. The apparatus according to claim 11, wherein each of the plurality of layer-printing documents includes a color information and a layer-height information corresponding to the color information, and the layer-height information includes a layer-height value.

15. The apparatus according to claim 14, wherein the color information includes a color mixing ratio which determines a ratio relationship between three primary colors, and
the layer-height information further includes a plurality of sub-layer-height values which are determined according to the color mixing ratio and the layer-height value.

16. The apparatus according to claim 15, wherein the document setting unit further obtains a target color according to the color mixing ratio and the plurality of sub-layer-height values corresponding to the color mixing ratio.

17. The apparatus according to claim 14, wherein the color information includes a grayscale color mixing ratio which determines a ratio relationship between black and white, and
the layer-height value further includes a plurality of sub-layer-height values which are determined according to the grayscale color mixing ratio and the layer-height value.

18. The apparatus according to claim 17, wherein the document setting unit further obtains a target color according to the grayscale color mixing ration and the plurality of sub-layer-height values corresponding to the grayscale color mixing ratio.

19. The apparatus according to claim 11, wherein the document setting unit integrates the plurality of layer-printing documents into the model printing document of the 3D object according to a height of the 3D object and a printing order of a bottom up.

20. The apparatus according to claim 11, wherein the document processing unit inputs the model printing document into the multi-nozzle 3D printer to print the 3D object.
